(19) United States
(12) Patent Application Publication
(10) Pub. No.: US 2018/0013625 A1
(43) Pub. Date: Jan. 11, 2018

(54) CONFIGURATION DATA DISTRIBUTION METHOD AND APPARATUS

(71) Applicant: ZTE CORPORATION, Shenzhen, Guangdong (CN)

(72) Inventors: Minghui GAO, Shenzhen, Guangdong (CN); Chendong YU, Shenzhen, Guangdong (CN); Huannan MA, Shenzhen, Guangdong (CN)

(21) Appl. No.: 15/548,970

(22) PCT Filed: Jan. 26, 2016
(86) PCT No.: PCT/CN2016/072198

§ 371 Date: Aug. 4, 2017

(30) Foreign Application Priority Data
Feb. 4, 2015 (CN) 201510059435.8

(51) Int. Cl. H04L 12/24; H04Q 11/00

(52) U.S. Cl. CPC H04L 41/0843; H04Q 2011/0079; H04L 2212/00; H04Q 11/0067

(57) ABSTRACT

The present disclosure provides a configuration data distribution method, including: determining an encapsulation manner of configuration data according to identifiers of Optical Network Units (ONUs) and a preset corresponding relationship between the identifiers of the ONUs and the encapsulation manner of the configuration data of the ONUs; and encapsulating the configuration data according to the determined encapsulation manner, and distributing the encapsulated configuration data to corresponding gateways according to the encapsulation manner of the ONUs or the identifiers of the ONUs.

### TECHNICAL FIELD

The present disclosure relates to the technical field of communications, and particularly relates to a configuration data distribution method and apparatus.

### BACKGROUND

A common networking system is shown in FIG. 1 in G-PON (Gigabit-capable Passive Optical Network)/EPON (Ethernet Passive Optical Network) devices of a passive optical network (PON) and other PON operation networks (xPON networks for short). The system is composed of an OLT (Optical Line Terminal), an ODN (Optical Distribution Network) and a plurality of ONUs (Optical Network Units), wherein the OLT serves as a central office device to forward services to an upper device through an SNI (Service Node Interface) and is connected and converged with a plurality of ONU devices through the ODN, and the ONU devices complete final access of user services through a UNI (User Node Interface), thereby realizing multiple functions, such as service transport, configuration, management and the like. The xPON is used as a “point-to-multipoint” topological structure: a transport direction from the OLT to the ONU is a downlink direction, data is transmitted in a broadcast mode in the downlink direction, and whether the data is valid and should be received or discarded is judged by the ONUs according to data identifiers; a transport direction from the ONU to the OLT is an uplink direction, TDM (Time Division Multiplexing) or WDM (Wavelength Division Multiplexing) may be adopted in the uplink direction according to different mechanisms: in the TDM, the TDM is adopted in the uplink direction, and an uplink burst signal must be transmitted by the ONU according to an uplink bandwidth time slot distributed by the OLT; and in the WDM, ONU uplink data is carried in a specific operating wavelength. In the xPON network, a single PON port of the OLT distinguishes and manages each ONU through a unique identifier: in the EPON, an MAC (Medium Access Control) address is a physical identifier of the ONU, and in the GPON, an SN (Serial Number) is the physical identifier of the ONU. Registration of each ONU on the PON system is completed through the physical identifier, and logic opening authentication is completed through the MAC address, the SN, a logical ONU identifier (LOID), a password (PW) and the like; and similar identifiers may be used in other PToMP networks and are configured to distinguish the OLT and manage each of the ONUs.

The ONUs can be managed by the OLT through a built-in OAM (Operation Administration and Maintenance) channel, and different xPONs are realized by adopting different OAM protocols respectively. For example, the EPON system adopts an extended OAM protocol, and the GPON system adopts an OMCI (ONU Management and Control Interface) protocol. By virtue of the protocols above, ONU service configuration is distributed to the ONUs to be locally effective, and service forwarding of the ONUs is guaranteed. Therefore, the ONUs not only complete basic physical line functions, but also need to realize two-layer or three-layer service transformation functions and other service-related functions as required.

Devices in the xPON system can be distributed to multiple usage scenarios such as FTTB (Fiber to The Building), FTTH (Fiber to the Home) and the like according to quantity of user ports and service forms of the ONUs, wherein the FTTH scenario is a scenario applied most widely at present, is generally connected with a home gateway unit through an SFU (Single Fiber Unit) to access multiple services of home users, such as broadband Internet, voice and IPTV (Interactive Personality TV), and can be directly accessed to an uplink HGU (Home Gateway Unit) of the PON. However, in the two manners above, since the home gateway is remotely deployed and functions such as related user access, service identification and transformation and the like need to be realized, defects of high cost and maintenance difficulty exist. With respect to the problems, a core function of the home gateway can be realized on an xPON OLT device, so that a device in the user home becomes a simple device with a line function only, thereby reducing technical complexity and a maintenance workload of a user-side home gateway device. The technology is called a virtual remote gateway, that is, a VRG technology. According to the technology, network maintenance cost can be effectively reduced, so that the traditional PON uplink home gateway unit and two different home access devices with the line function only may simultaneously exist under the same GPON OLT device. However, a solution of performing unified configuration and management on the two home access devices cannot be proposed in the scenarios above in the existing art. Apparently, a method for performing unified configuration and management on different gateways needs to be proposed.

### SUMMARY

The present disclosure provides a configuration data distribution method and apparatus, used for solving a problem in an existing art that a unified configuration management solution on two home gateway access devices does not exist.

According to one aspect of embodiments of the present disclosure, a configuration data distribution method is provided, including: determining an encapsulation manner of configuration data according to identifiers of optical network units (ONUs) and a preset corresponding relationship between the identifiers of the ONUs and the encapsulation manner of the configuration data of the ONUs; and encapsulating the configuration data according to the determined encapsulation manner, and distributing the encapsulated configuration data to corresponding gateways according to the encapsulation manner of the ONUs or the identifiers of the ONUs.

A step of determining the encapsulation manner of the configuration data according to the identifiers of the ONUs and the preset corresponding relationship between the identifiers of the ONUs and the encapsulation manner of the configuration data of the ONUs includes: determining a preset user data configuration template needed for encapsulating the configuration data according to the identifiers of the ONUs and the preset corresponding relationship between the identifiers of the ONUs and the encapsulation manner of the configuration data of the ONUs, wherein a data encapsulation manner is specified in the user data configuration template.

Optionally, the method further includes: creating user data configuration templates corresponding to types of the gateways according to the types of the gateways used by the ONUs, and setting a corresponding relationship between the user data configuration templates and the identifiers of the ONU before the encapsulation manner of the configuration data is determined according to the identifiers of the ONUs and the preset corresponding relationship between the identifiers of the ONUs and the encapsulation manner of the configuration data of the ONUs.

A step of encapsulating the configuration data according to the determined encapsulation manner and distributing the encapsulated configuration data to corresponding gateways according to the encapsulation manner of the ONUs or the identifiers of the ONUs includes: judging whether the configuration data corresponds to an entity home gateway or a virtual remote gateway according to the encapsulation manner of the configuration data when the ONUs corresponding to the current entity home gateway or virtual remote gateway are online; judging whether the configuration data corresponds to the entity home gateway or the virtual remote gateway according to identifiers reported by the ONUs when the ONUs corresponding to the current entity home gateway or virtual remote gateway are newly online; distributing the configuration data to a virtual remote gateway module and line units in a user home according to functional partitioning of the virtual remote gateway module on an optical line terminal (OLT) and the line units in the user home under a condition that the configuration data is judged to correspond to the virtual remote gateway; and distributing service configuration data to the entity home gateway through an extended operation administration and maintenance (OAM)/ONU management and control interface (OMCI) channel under a condition that the configuration data is judged to correspond to the entity home gateway.

Optionally, the method further includes: judging whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distributing the service-related data to a gateway virtual unit on the OLT side and taking into effect if the configuration data is the service-related data, and distributing the line-related data to a remote line unit through the extended OAM/OMCI channel if the configuration data is the line-related data.

According to another aspect of embodiments of the present disclosure, a configuration data distribution apparatus is provided, including a determining module configured to determine an encapsulation manner of configuration data according to identifiers of optical network units (ONUs) and a preset corresponding relationship between the identifiers of the ONUs and the encapsulation manner of the configuration data of the ONUs; and a first distributing module configured to encapsulate the configuration data according to the determined encapsulation manner and distribute the encapsulated configuration data to corresponding gateways according to the encapsulation manner of the ONUs or the identifiers of the ONUs.

The determining module is configured to determine a preset user data configuration template needed for encapsulating the configuration data according to the identifiers of the ONUs and the preset corresponding relationship between the identifiers of the ONUs and the encapsulation manner of the configuration data of the ONUs, wherein a data encapsulation manner is specified in the user data configuration template.

Optionally, the apparatus further includes a setting module configured to create user data configuration templates corresponding to types of the gateways according to the types of the gateways used by the ONUs, and set a corresponding relationship between the user data configuration templates and the identifiers of the ONUs before the encapsulation manner of the configuration data is determined according to the identifiers of the ONUs and the preset corresponding relationship between the identifiers of the ONUs and the encapsulation manner of the configuration data of the ONUs.

The first distributing module includes a first judging unit configured to judge whether the configuration data corresponds to an entity home gateway or a virtual remote gateway according to the encapsulation manner of the configuration data when the ONUs corresponding to the current entity home gateway or virtual remote gateway are online; a second judging unit configured to judge whether the configuration data corresponds to the entity home gateway or the virtual remote gateway according to identifiers reported by the ONUs when the ONUs corresponding to the current entity home gateway or virtual remote gateway are newly online; a first distributing unit configured to distribute the configuration data to a virtual remote gateway module and line units in user home according to functional partitioning of the virtual remote gateway module on an optical line terminal (OLT) and the line units in the user home under a condition that the configuration data is judged to correspond to the virtual remote gateway; and a second distributing unit configured to distribute service configuration data to the entity home gateway through an extended operation administration and maintenance (OAM)/ONU management and control interface (OMCI) channel under a condition that the configuration data is judged to correspond to the entity home gateway.

Optionally, the apparatus further includes a second distributing module configured to judge whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distribute the service-related data to a gateway virtual unit on the OLT side and take the data into effect if the configuration data is the service-related data, and distribute the line-related data to a remote line unit through the extended OAM/OMCI channel if the configuration data is the line-related data.

According to embodiments of the present disclosure, the configuration data is encapsulated according to a preset configuration data encapsulation manner corresponding to the identifiers of the terminals, and distributed to the corresponding gateways according to the encapsulation manner of the configuration data or the identifiers of the terminals, so that the terminals using different gateways are managed and configured in a unified manner.

### BRIEF DESCRIPTION OF DRAWINGS

Drawings described herein are used for providing a further understanding of the present disclosure and forming part of the present application. Illustrative embodiments of the present disclosure and descriptions thereof are used for explaining the present disclosure, rather than forming an improper limitation to the present disclosure. In the drawings:

FIG. 1 is a structural block diagram illustrating a networking system of G-PON/EPON in an existing art;

FIG. 2 is a flow chart illustrating a configuration data distribution method in embodiment I of the present disclosure;

FIG. 3 is a flow chart illustrating a configuration data distribution method in embodiment II of the present disclosure;

FIG. 4 is a structural block diagram illustrating a configuration data distribution apparatus of the present embodiment.

### DETAILED DESCRIPTION

The present disclosure provides a configuration data distribution method and apparatus, for solving a problem in an existing art that a unified configuration management solution of two home gateway access devices does not exist. The present disclosure will be further described in detail below in combination with drawings and embodiments. It should be understood that specific embodiments described herein are used for explaining the present disclosure only rather than limiting the present disclosure.

### Embodiment I

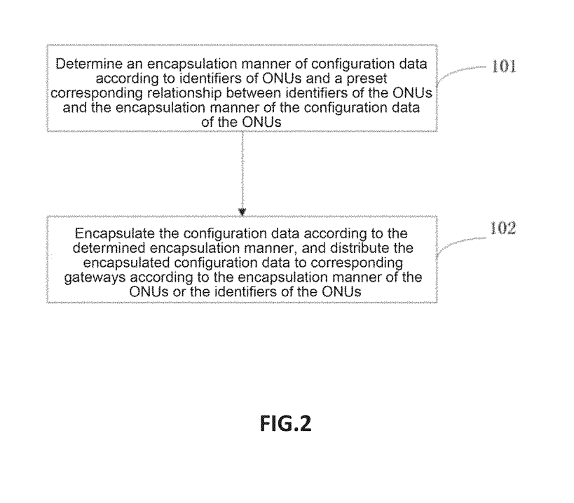

The present embodiment provides a configuration data distribution method. The method can be implemented by an OLT and is mainly used for achieving purposes of distinguishing encapsulation manners of configuration data belonging to different gateways and distributing the configuration data to the gateways to which the configuration data belongs. FIG. 2 is a flow chart illustrating a configuration data distribution method in embodiment I of the present disclosure. As shown in FIG. 2, the method may specifically include following processing.

In step 101: an encapsulation manner of configuration data is determined according to identifiers of the ONUs and a preset corresponding relationship between the identifiers of the ONUs and the encapsulation manner of the configuration data of the ONUs;

in the step 101, the identifiers of the ONUs may include registration identifiers reported when the ONUs are online, other authentication data capable of identifying the ONUs or types of the ONUs.

In step 102: the configuration data is encapsulated according to the determined encapsulation manner, and the encapsulated configuration data is distributed to corresponding gateways according to the encapsulation manner of the ONUs or the identifiers of the ONUs.

After the step 102, whether the configuration data is service-related data or line-related data is judged under the condition that the configuration data is judged to correspond to a virtual remote gateway, the service-related data is distributed to a gateway virtual unit on the OLT side and taken into effect if the configuration data is the service-related data, and the line-related data is distributed to a remote line unit through an extended OAM/OMCI channel if the configuration data is the line-related data.

On the basis of the step 101, in order to more efficiently determine the encapsulation manner of the configuration data at a great configuration data volume, optionally the step 101 can be implemented according to following specific manners:

a preset user data configuration template needed for encapsulating the configuration data is determined according to the identifiers of the ONUs, wherein a data encapsulation manner is specified in the user data configuration template; and herein, specific steps of presetting the user data configuration template are as follows:

user data configuration templates corresponding to types of gateways are created according to the types of the gateways used by the ONUs, and a corresponding relationship between the user data configuration templates and the identifiers of the ONUs is set before the encapsulation manner of the configuration data is determined according to the identifiers of the ONUs.

The encapsulating the configuration data according to the determined encapsulation manner and distributing the encapsulated configuration data to corresponding gateways according to the encapsulation manner of the ONUs or the identifiers of the ONUs based on the preset user data configuration template may specifically include:

whether the configuration data corresponds to an entity home gateway or a virtual remote gateway is judged according to the encapsulation manner of the configuration data when the ONUs corresponding to the current entity home gateway or virtual remote gateway are online;

whether the configuration data corresponds to the entity home gateway or the virtual remote gateway is judged according to identifiers reported by the ONUs when the ONUs corresponding to the current entity home gateway or virtual remote gateway are newly online;

the configuration data is distributed to a virtual remote gateway module and line units in a user home according to functional partitioning of the virtual remote gateway module on an optical line terminal (OLT) and the line units in the user home under a condition that the configuration data is judged to correspond to the virtual remote gateway; and

service configuration data is distributed to the entity home gateway through the OAM/OMCI channel under a condition that the configuration data is judged to correspond to the entity home gateway.

According to the method provided by the present embodiment, convenient HGU/VRG management and automatic service fulfillment can be realized in xPON present network applications by establishing corresponding relationships between identifiers of device terminals and the user data configuration templates, and specific user configuration can be neglected so as to automatically realize functions such as distribution of the configuration data, service restoration and the like. Operation and maintenance needs of xPON network operators are met, and needs of terminal users are also met while service implementation complexity of user-side terminal devices is reduced and operation and maintenance cost is reduced.

### Embodiment II

The present embodiment provides a method for realizing centralized unified configuration and management in a passive optical network system based on a hybrid networking condition that a traditional home gateway unit and a virtual remote gateway unit are intelligently accessed to two devices. Identifiers of terminals of VRG (including but not limited to MAC of EPON or SN of GPON, or PW (password)/LOID (Logical ID) and other authentication related parameters capable of performing unique identification on ONUs and the like) are bound to different user data configuration templates, and the OLT automatically calls different user data configuration templates according to terminal type identifiers after the terminal of the HGU/VRG is preliminarily online and a management channel is established, thereby realizing a method for automatically managing and opening different HGU/VRG services in one xPON network.

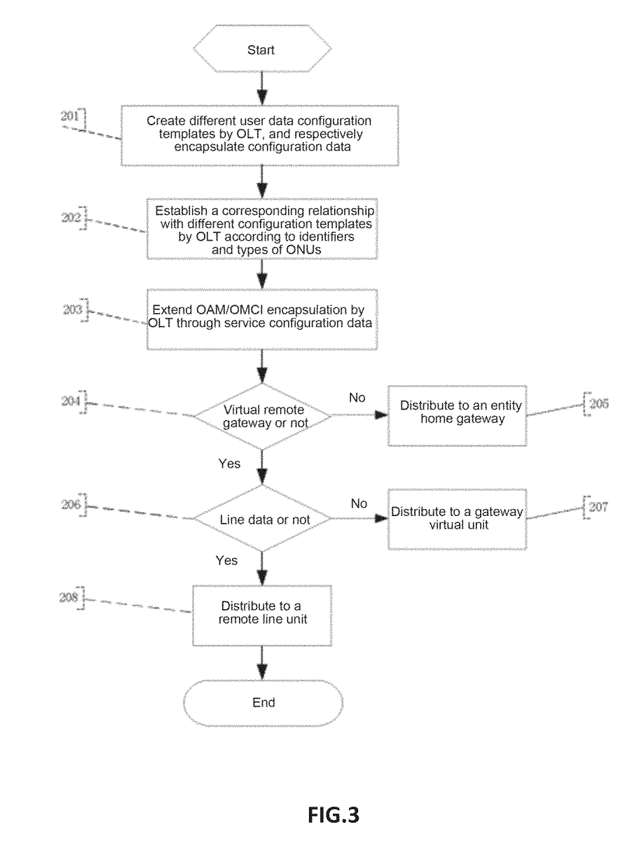

In the present embodiment, according to an implementation sample in the xPON network according to a configuration method distribution method proposed by the present disclosure, configuration of corresponding data is completed on the OLT according to actual service needs, and data configuration and management are completed between the OLT and a terminal device through the extended OAM/OMCI channel. FIG. 3 is a flow chart illustrating a configuration data distribution method in embodiment II of the present disclosure. As shown in FIG. 3, the method may specifically include following steps:

S201: user data configuration templates are respectively created by the OLT with respect to users using the traditional home gateway units, that is, the entity home gateway and the virtual remote gateway, and are used for distinguishing two different user devices, wherein data encapsulated by different user data configuration templates are different;

S202: registration identifiers and types are reported when the ONUs are online, and corresponding relationships with different user data configuration templates are established by the OLT according to the ONU registration identifiers (or other authentication data capable of identifying the ONUs) and types of the ONUs;

S203: service configuration data is subjected to extended OAM/OMCI encapsulation by the OLT according to specific types of the ONUs by referring to different user data configuration templates. The specific configured service data can neglect differences of the two different devices, is configured according to service data needed by normal traditional home gateway units, and includes but not limited to corresponding ONU ID numbers, LLID (Logical Link Identify) or Gem-Port, DBA (Dynamic Bandwidth Allocation), VLAN (Virtual Local Area Network) and other service channel related parameters. The configuration data further includes interface rates, operating modes and other physical port parameters of corresponding terminal devices and other related parameters.

S204: the related configuration data is directly distributed when a remote line unit corresponding to the entity home gateway or the virtual remote gateway is online, otherwise the data is saved on the OLT and then distributed after the devices above are online.

The configuration data needs to be distributed to the entity home gateway or a virtual remote gateway module on the xPON OLT device and the remote line unit according to judgment of the user data configuration templates. For configuration data of the virtual remote gateway, the configuration data needed by service fulfillment can be respectively distributed to the virtual remote gateway module on the OLT and line units in user home according to function module partitioning and is adopted and distributed to extended OAM frames/OMCI frames similar to entity home gateway units in a unified manner.

S205: The OLT judges whether newly online ONUs belong to the virtual remote gateway according to the identifiers and types of the ONUs and performs corresponding processing when the ONUs are online. All the data are distributed onto the entity home gateway through the extended OAM/OMCI channel by referring to corresponding user data configuration templates and are taken into effect on the entity home gateway when the newly online ONUs are judged to not belong to the virtual remote gateway.

S206: The corresponding user data configuration templates are referred and distribution positions of the service data are judged according to the judgment whether the configuration data is line data if the newly online ONUs are judged to belong to the virtual remote gateway.

S207: Service-related data is distributed to a gateway virtual unit on the OLT side and taken into effect if the configuration data is the service-related data (including but not limited to service marking, service forwarding, routing and other related configurations).

S208: The configuration data is distributed to the remote line unit through the extended OAM/OMCI channel and taken into effect on the remote line unit if the configuration data is the line-related data, and finally service distribution of the virtual remote gateway is completed.

Corresponding virtual remote gateway modules are notified to stop working through inside information of the xPON OLT if the line unit corresponding to the virtual remote gateway is power-off; configuration of the virtual remote gateway is redistributed to the virtual remote gateway modules and remote line units according to the method above after the xPON OLT detects that the line unit is electrified, thereby ensuring timely service restoration of terminal users; and configuration of the entity home gateway is redistributed to the entity home gateway according to the method above after the xPON OLT detects that the entity home gateway is electrified, thereby ensuring timely service restoration.

### Embodiment III

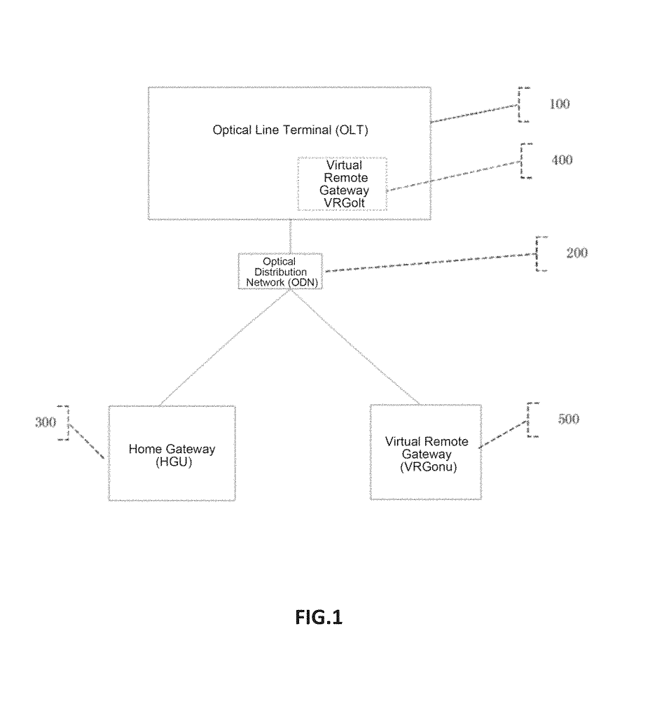

As shown in a schematic diagram of a system in FIG. 1, the system provided by the present embodiment includes OLT100, ODN200, HGU300, VRGolt400 and VRGonu500, wherein the OLT100 is configured to generate related service configuration data and a mapping table between identifiers/types of terminal devices (HGU/VRG) and user data configuration templates according to actual needs, and is used for starting an online discovery process of the ONUs and controlling the corresponding HGU/VRG to respectively complete an accurate data configuration process according to a mapping relationship after the identifiers/types of terminal devices, that is, the ONUs, are acquired. The service configuration data is only related to specific services, while not related to the types of the ONUs.

For the HGU300, the service configuration data is totally distributed according to the corresponding user data configuration templates and taken into effect on the HGU300 side; for the ONUs of the VRG type, the service configuration data is divided into two parts according to the corresponding configuration templates; line unrelated service data is distributed to a virtual VRGolt400 module on the OLT100 side; and the line-related data is distributed to the VRGonu500 on a remote ONU side, and management and configuration of the virtual remote gateway are realized by the virtual remote gateway VRGolt400 on the OLT side and a remote line terminal VRGonu500.

The ODN200 is configured to serve as a direct physical connection channel between the OLT100 and the ONUs when the ONUs of different quantities (including but not limited to the HGU300 and VRGonu500) are connected under corresponding PON ports of the OLT100, and may be composed of a combination of multiple passive optical physical devices, connecting cables of the devices and the like.

The HGU300 is configured to play a role of accessing a terminal device into the xPON network, receives management of OLT200 and realizes local service marking, forwarding, routing and other functions according to configuration distributed by the OLT200.

The VRGolt400 serves as an OLT software module of the virtual remote gateway, receives the management of the OLT200 and realizes service marking, forwarding, routing and other non-line configuration functions of the virtual remote gateway according to the configuration distributed by the OLT200.

The VRGonu500 serves as a remote line terminal of the virtual remote gateway, is an entity terminal part of the virtual remote gateway, is positioned on the ONU side, receives the management of the OLT200 and realizes line-related configuration and functions according to the configuration distributed by the OLT.

### Embodiment IV

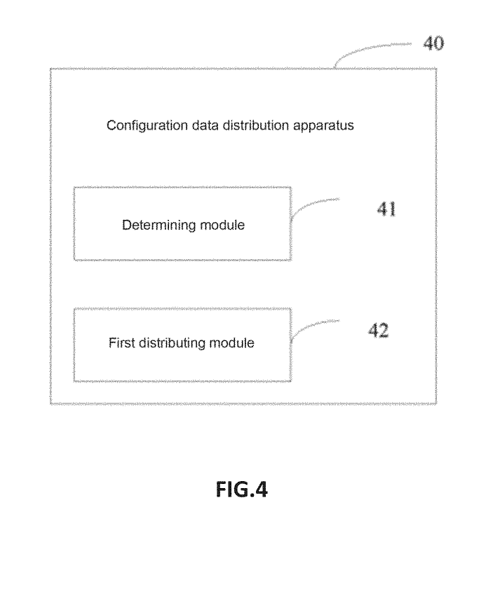

The present embodiment provides a configuration data distribution apparatus. The apparatus is used for realizing the configuration data distribution method provided in embodiments 1 and 2 above, and may be preferably arranged in the OLT. FIG. 4 is a structural block diagram illustrating the configuration data distribution apparatus of the present embodiment. As shown in FIG. 4, the apparatus 40 includes following components:

a determining module 41, configured to determine an encapsulation manner of configuration data according to identifiers of optical network units (ONUs) and a preset corresponding relationship between the identifiers of the ONUs and the encapsulation manner of the configuration data of the ONUs; and

a first distributing module 42, configured to encapsulate the configuration data according to the determined encapsulation manner and distribute the encapsulated configuration data to corresponding gateways according to the encapsulation manner of the ONUs or the identifiers of the ONUs.

The determining module 41 is configured to determine a preset user data configuration template needed for encapsulating the configuration data according to the identifiers of the ONUs and the preset corresponding relationship between the identifiers of the ONUs and the encapsulation manner of the configuration data of the ONUs, wherein a data encapsulation manner is specified in the user data configuration template.

Optionally, the above apparatus 40 may further include: a setting module, configured to create user data configuration templates corresponding to types of the gateways according to the types of the gateways used by the ONUs, and set a corresponding relationship between the user data configuration templates and the identifiers of the ONUs before the encapsulation manner of the configuration data is determined according to the identifiers of the ONUs and the preset corresponding relationship between the identifiers of the ONUs and the encapsulation manner of the configuration data of the ONUs.

The first distributing module 42 may specifically include: a first judging unit, configured to judge whether the configuration data corresponds to an entity home gateway or a virtual remote gateway according to the encapsulation manner of the configuration data when the ONUs corresponding to the current entity home gateway or virtual remote gateway are online; a second judging unit, configured to judge whether the configuration data corresponds to the entity home gateway or the virtual remote gateway according to identifiers reported by the ONUs when the ONUs corresponding to the current entity home gateway or virtual remote gateway are newly online; a first distributing unit, configured to distribute the configuration data to a virtual remote gateway module and line units in a user home according to functional partitioning of the virtual remote gateway module on an optical line terminal (OLT) and the line units in the user home under a condition that the configuration data is judged to correspond to the virtual remote gateway; and a second distributing unit, configured to distribute service configuration data to the entity home gateway through an OAM/OMCI channel under a condition that the configuration data is judged to correspond to the entity home gateway.

Optionally, the above apparatus 40 may further include: a second distributing module, configured to judge whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distribute the service-related data to a gateway virtual unit on the OLT side and take into effect if the configuration data is the service-related data, and distribute the line-related data to a remote line unit through the extended OAM/OMCI channel if the configuration data is the line-related data.

Although preferred embodiments of the present disclosure are disclosed for the purpose of illustration, those skilled in the art should understand that various improvements, additions and replacements are possible. Therefore, the scope of the present disclosure should not be limited to embodiments above.

### INDUSTRIAL APPLICABILITY

In the configuration data distribution process of embodiments of the present disclosure, the configuration data is encapsulated according to a preset configuration data encapsulation manner corresponding to identifiers of terminals and distributed to corresponding gateways according to the configuration data encapsulation manner or the identifiers of the terminals, so that the terminals using different gateways are managed and configured in a unified manner.

1. A configuration data distribution method, comprising:
determining an encapsulation manner of configuration data according to identifiers of Optical Network Units (ONUs) and a preset corresponding relationship between the identifiers of the ONUs and the encapsulation manner of the configuration data of the ONUs; and
encapsulating the configuration data according to the determined encapsulation manner, and distributing the encapsulated configuration data to corresponding gateways according to the encapsulation manner of the ONUs or the identifiers of the ONUs.

2. The method according to claim 1, wherein the determining the encapsulation manner of the configuration data according to the identifiers of ONUs and the preset corresponding relationship between the identifiers of the ONUs and the encapsulation manner of the configuration data of the ONUs comprises:
determining a preset user data configuration template needed for encapsulating the configuration data according to the identifiers of the ONUs and the preset corresponding relationship between the identifiers of the ONUs and the encapsulation manner of the configuration data of the ONUs, wherein a data encapsulation manner is specified in the user data configuration template.

3. The method according to claim 2, further comprising:
creating user data configuration templates corresponding to types of the gateways according to the types of the gateways used by the ONUs, and setting a corresponding relationship between the user data configuration templates and the identifiers of the ONUs before determining the encapsulation manner of the configuration data according to the identifiers of the ONUs and the preset corresponding relationship between the identifiers of the ONUs and the encapsulation manner of the configuration data of the ONUs.

4. The method according to claim 1, wherein the encapsulating the configuration data according to the determined encapsulation manner and distributing the encapsulated configuration data to corresponding gateways according to the encapsulation manner of the ONUs or the identifiers of the ONUs comprises:
judging whether the configuration data corresponds to an entity home gateway or a virtual remote gateway according to the encapsulation manner of the configuration data when the ONUs corresponding to the current entity home gateway or virtual remote gateway are online;
judging whether the configuration data corresponds to the entity home gateway or the virtual remote gateway according to identifiers reported by the ONUs when the ONUs corresponding to the current entity home gateway or virtual remote gateway are newly online;
distributing the configuration data to a virtual remote gateway module and line units in a user home according to functional partitioning of the virtual remote gateway module on an Optical Line Terminal (OLT) and the line units in the user home under a condition that the configuration data is judged to correspond to the virtual remote gateway; and
distributing service configuration data to the entity home gateway through an extended Operation Administration and Maintenance (OAM)/ONU Management and Control Interface (OMCI) channel under a condition that the configuration data is judged to correspond to the entity home gateway.

5. The method according to claim 1, further comprising:
judging whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distributing the service-related data to a gateway virtual unit on the OLT side and taking into effect if the configuration data is the service-related data, and distributing the line-related data to a remote line unit through the extended OAM/OMCI channel if the configuration data is the line-related data.

6. A configuration data distribution apparatus, comprising:
a determining module, configured to determine an encapsulation manner of configuration data according to identifiers of Optical Network Units (ONUs) and a preset corresponding relationship between the identifiers of the ONUs and the encapsulation manner of the configuration data of the ONUs; and
a first distributing module, configured to encapsulate the configuration data according to the determined encapsulation manner and distribute the encapsulated configuration data to corresponding gateways according to the encapsulation manner of the ONUs or the identifiers of the ONUs.

7. The apparatus according to claim 6, wherein the determining module is configured to:
determine a preset user data configuration template needed for encapsulating the configuration data according to the identifiers of the ONUs and the preset corresponding relationship between the identifiers of the ONUs and the encapsulation manner of the configuration data of the ONUs, wherein a data encapsulation manner is specified in the user data configuration template.

8. The apparatus according to claim 7, further comprising:
a setting module, configured to create user data configuration templates corresponding to types of the gateways according to the types of the gateways used by the ONUs, and set a corresponding relationship between the user data configuration templates and the identifiers of the ONUs before the encapsulation manner of the configuration data is determined according to the identifiers of the ONUs and the preset corresponding relationship between the identifiers of the ONUs and the encapsulation manner of the configuration data of the ONUs.

9. The apparatus according to claim 6, wherein the first distributing module comprises:
a first judging unit, configured to judge whether the configuration data corresponds to an entity home gateway or a virtual remote gateway according to the encapsulation manner of the configuration data when the ONUs corresponding to the current entity home gateway or virtual remote gateway are online;
a second judging unit, configured to judge whether the configuration data corresponds to the entity home gateway or the virtual remote gateway according to identifiers reported by the ONUs when the ONUs corresponding to the current entity home gateway or virtual remote gateway are newly online;
a first distributing unit, configured to distribute the configuration data to a virtual remote gateway module and line units in a user home according to functional partitioning of the virtual remote gateway module on an Optical Line Terminal (OLT) and the line units in the user home under a condition that the configuration data is judged to correspond to the virtual remote gateway; and
a second distributing unit, configured to distribute service configuration data to the entity home gateway through an extended Operation Administration and Maintenance (OAM)/ONU Management and Control Interface (OMCI) channel under a condition that the configuration data is judged to correspond to the entity home gateway.

10. The apparatus according to claim 6, further comprising:
a second distributing module, configured to judge whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distribute the service-related data to a gateway virtual unit on the OLT side and take into effect if the configuration data is the service-related data, and distribute the line-related data to a remote line unit through the extended OAM/OMCI channel if the configuration data is the line-related data.

11. The method according to claim 2, further comprising:
judging whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distributing the service-related data to a gateway virtual unit on the OLT side and taking into effect if the configuration data is the service-related data, and distributing the line-related data to a remote line unit through the extended OAM/OMCI channel if the configuration data is the line-related data.

12. The method according to claim 3, further comprising:
judging whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distributing the service-related data to a gateway virtual unit on the OLT side and taking into effect if the configuration data is the service-related data, and distributing the line-related data to a remote line unit through the extended OAM/OMCI channel if the configuration data is the line-related data.

13. The method according to claim 4, further comprising:
judging whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distributing the service-related data to a gateway virtual unit on the OLT side and taking into effect if the configuration data is the service-related data, and distributing the line-related data to a remote line unit through the extended OAM/OMCI channel if the configuration data is the line-related data.

14. The apparatus according to claim 7, further comprising:
a second distributing module, configured to judge whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distribute the service-related data to a gateway virtual unit on the OLT side and take into effect if the configuration data is the service-related data, and distribute the line-related data to a remote line unit through the extended OAM/OMCI channel if the configuration data is the line-related data.

15. The apparatus according to claim 8, further comprising:
a second distributing module, configured to judge whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distribute the service-related data to a gateway virtual unit on the OLT side and take into effect if the configuration data is the service-related data, and distribute the line-related data to a remote line unit through the extended OAM/OMCI channel if the configuration data is the line-related data.

16. The apparatus according to claim 9, further comprising:
a second distributing module, configured to judge whether the configuration data is service-related data or line-related data after the encapsulated configuration data is distributed to the corresponding gateways according to the encapsulation manner of the ONUs or the identifiers of the ONUs under the condition that the configuration data is judged to correspond to the virtual remote gateway, distribute the service-related data to a gateway virtual unit on the OLT side and take into effect if the configuration data is the service-related data, and distribute the line-related data to a remote line unit through the extended OAM/OMCI channel if the configuration data is the line-related data.
